(19) United States
(12) Patent Application Publication
(10) Pub. No.: US 2004/0124300 A1
(43) Pub. Date: Jul. 1, 2004

(54) Recording tape cartridge

(75) Inventor: Kazuo Hiraguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/699,799

(22) Filed: Nov. 4, 2003

(30) Foreign Application Priority Data
Dec. 27, 2002 (JP) 2002-380342

(51) Int. Cl. G11B 23/107

(52) U.S. Cl. 242/348

(57) ABSTRACT

A recording tape cartridge is formed from a substantially rectangular case. The case is formed from an upper case, at which a first peripheral wall stands erect at a ceiling plate, and a lower case, at which a second peripheral wall stands erect at a floor plate. The case rotatably accommodates a reel on which a recording tape is wound. At least one screw boss, which is for joining the upper case and the lower case together, is disposed at a position of the upper case and the lower case. The screw boss has a structure in which a convex portion and a concave portion are fit together. A thickness of a border between the first peripheral wall and the ceiling plate and a border between the first peripheral wall and the floor plate is formed to be thinner than a thickness of the second peripheral wall.

### CROSS-REFERENCE TO RELATED APPLICATION

This application claims priority under 35 USC 119 from Japanese Patent Application No. 2002-380342, the disclosure of which is incorporated by reference herein.

### BACKGROUND OF THE INVENTION

1. Technical Field

The present invention relates to a tape cartridge including a case and a single reel which is contained in the case and around which a recording tape such as a magnetic tape used as a record reproducing medium for a computer, is wound.

2. Description of the Related Art

A magnetic tape cartridge is known that includes a single reel which is contained in a case and around which a magnetic tape used as a data record reproducing medium for a computer is wound, is conventionally known. A leader member, such as a leader block, leader pin or leader tape, is fixed to a leading end of the magnetic tape. The leader member is drawn from the magnetic tape cartridge by a drawing device provided in a drive system. The magnetic tape fastened to the leader member is wound around a take-up reel of the drive system.

In addition, a reel gear is inscribed in an annular shape at a center of a lower surface of the reel, which is exposed through the hole formed at a lower surface of the magnetic tape cartridge. A driving gear provided on a rotating shaft of the drive system is engaged with the reel gear to rotate the reel. Data is recorded onto the magnetic tape and the recorded data is reproduced by synchronously rotating the reel of the magnetic tape cartridge and the take-up reel of the drive system.

In a magnetic tape cartridge having such a structure, the case, which is made of synthetic resin and in which is accommodated a single reel around which a magnetic tape is wound, is mainly formed by an upper case and a lower case, each of which is substantially shaped as a rectangular tray, being joined together by thermal welding, screws, or the like. In particular, when the upper case and the lower case are joined together by screws, screw bosses, which oppose and abut one another, stand erect in vicinities of the corner portions of the upper case and the lower case, and the like. Screws are screwed into the screw bosses from the bottom surface (floor surface) side of the lower case such that the upper case and the lower case are joined together (see, for example, Japanese Patent Application Laid-Open (JP-A) No. 11-339436).

However, in a case in which the upper and lower cases are joined together by screws, the positions at which the screw bosses of the upper case and the screw bosses of the lower case abut one another (the positions of the holes) may be slightly offset due to errors in the molding of the upper case and the lower case. When the screws are screwed-in in such a state, there is the concern that strain or the like may arise at the assembled case due to this offset between the screw bosses. If strain arises at the case, in the case of a magnetic tape cartridge which is equipped with a door which opens and closes the opening by sliding, the relative positions of the door and the case will be offset, and problems will arise with respect to the ability of the door to slide.

Therefore, there is the need to improve the accuracy of molding of the upper case and the lower case. However, there are places where errors inevitably arise due to differences in the cooling time of the synthetic resin. Namely, as shown in FIG. 7A for example, at a curved portion 66C which is the border portion between a ceiling plate 66B and a peripheral wall 66A of an upper case 66, and at a curved portion 68C which is the border portion between a floor plate 68B and a peripheral wall 68A of a lower case 68, more synthetic resin of an amount corresponding to the curved portion is needed, and these portions are thick. Thus, it is more difficult for these portions to cool than other portions.

As a result, as shown in FIG. 7B, there are cases in which the peripheral walls 66A, 68A, which cool more quickly than the curved portions 66C, 68C, are unfortunately molded so as to lean slightly in toward the inner sides of the upper case 66 and the lower case 68. When this leaning-in occurs at the peripheral wall (side wall) side where the door slides, it affects the amount of projection of an operating member for opening/closing the door which projects from that peripheral wall (side wall) and engages with an opening/closing member of a drive device (i.e., the amount of engagement of the operating member with the opening/closing member is affected). Depending on the case, it may not be possible for the opening/closing member to engage with the operating member, i.e., it may not be possible to open the door.

### SUMMARY OF THE INVENTION

An object of the present invention is to provide a recording tape cartridge in which the accuracy of molding an upper case and a lower case is improved, the accuracy of joining together screw bosses for screwing together of the upper case and the lower case is improved, and problems in the operations of opening and closing a shielding member (a door) which opens and closes an opening do not arise.

In order to achieve the above object, a recording tape cartridge of a first aspect of the present invention comprises: a case which is substantially rectangular and is formed from an upper case, at which a peripheral wall stands erect at a ceiling plate, and a lower case, at which a peripheral wall stands erect at a floor plate, the case rotatably accommodating a single reel on which a recording tape is wound; and a screw boss disposed at a predetermined position of the upper case and the lower case, for joining the upper case and the lower case together, wherein the screw boss has a special structure in which a convex portion and a concave portion are fit together, and a thickness of a border portion between the peripheral wall and the ceiling plate and a border portion between the peripheral wall and the floor plate is formed to be thinner than a thickness of the peripheral wall.

In the present invention, the thickness of the border portion between the peripheral wall and the ceiling plate and the border portion between the peripheral wall and the floor plate is formed to be thinner than the thickness of the peripheral wall. Therefore, the cooling time of the synthetic resin at these portions can be made to be shorter than the cooling time of the peripheral wall. Accordingly, because the border portions harden first, it is possible to prevent the peripheral wall from leaning in toward the inner side of the case. Moreover, because the screw boss at the upper case and the screw boss at the lower case have the above-described structure, the accuracy of assembling the screw bosses together can be improved. Accordingly, strain or the like does not arise at the case, and the relative positional accuracy of the peripheral wall and the shielding member, which opens and closes the opening, can be ensured. Therefore, it is possible to prevent problems in the opening and closing operations of the shielding member from arising.

Moreover, in the recording tape cartridge of the first aspect, the thickness of the border portions may be set to be 50% to 85% of the thickness of the peripheral wall.

When the thickness of the border portions is set to such a value, the strength of the case at the border portions does not deteriorate, and falling-in of the peripheral wall can be prevented.

### BRIEF DESCRIPTION OF THE DRAWINGS

FIG. 1 is a schematic perspective view of a recording tape cartridge.

FIG. 2 is a schematic exploded perspective view of the recording tape cartridge.

FIG. 3 is a schematic perspective view of a lower case.

FIG. 4 is a schematic perspective view of an upper case.

FIG. 5 is an enlarged perspective view showing the structure of a screw boss of the upper case and a screw boss of the lower case.

FIG. 6 is a schematic side sectional view of the upper case and the lower case.

FIGS. 7A and 7B are schematic side sectional views of a conventional upper case and lower case.

### DETAILED DESCRIPTION OF THE INVENTION

Hereinafter, a recording tape cartridge 10 relating to an embodiment of the present invention will be described on the basis of the drawings. First, the overall structure of the recording tape cartridge 10 will be briefly described, and then, the main portions relating to the present invention will be described in detail. Note that, for convenience of explanation, the direction of loading the recording tape cartridge 10 into a drive device is denoted by arrow A, and this direction is called the forward direction (front side) of the recording tape cartridge 10. Further, the direction of arrow B, which is orthogonal to arrow A, is the rightward direction.

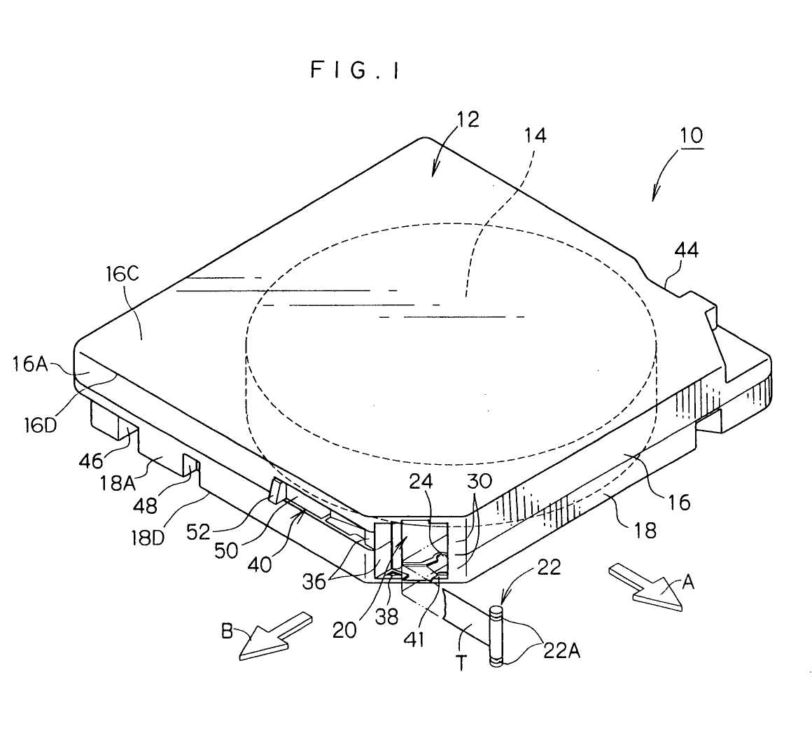

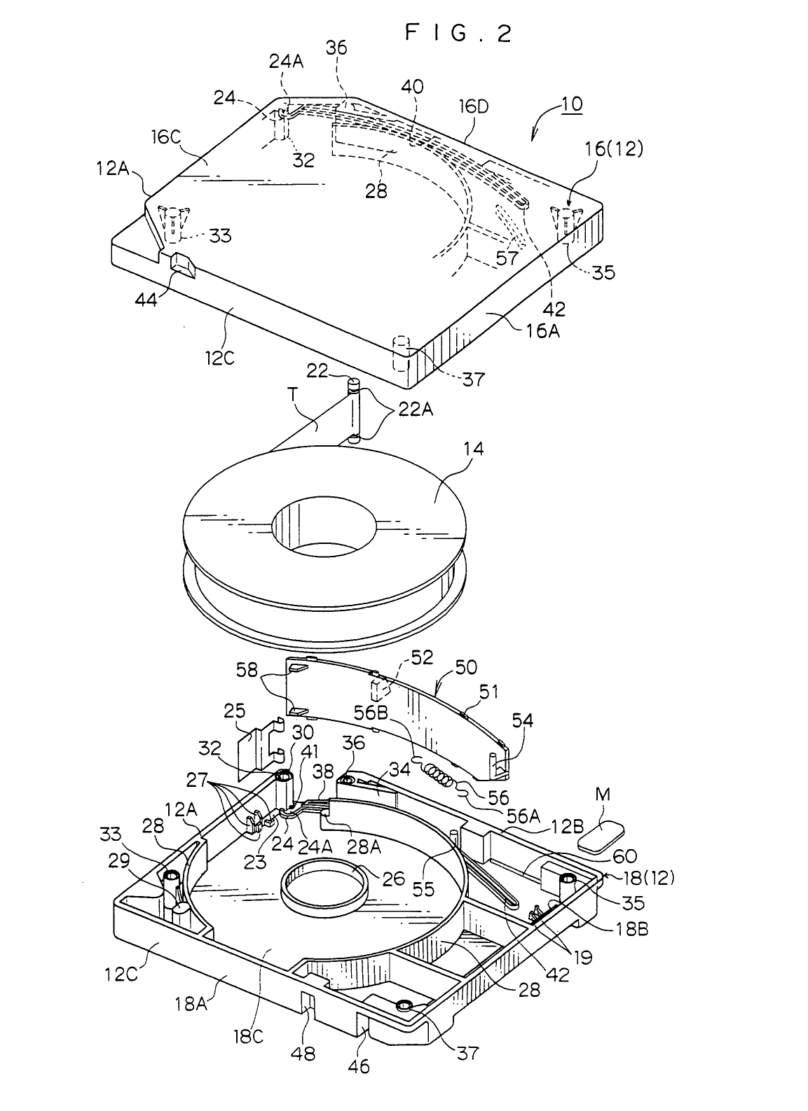

As shown in FIGS. 1 and 2, the recording tape cartridge 10 is structured such that a single reel 14, on which is wound a magnetic tape T serving as a recording tape which is an information recording/playback medium, is rotatably accommodated within a case 12 which is substantially rectangular as seen in plan view. The case 12 is formed by peripheral walls 16A and 18A of an upper case 16 and a lower case 18 being set to oppose one another and being joined together. At each of the peripheral walls 16A, 18A, the front right corner portion, which is one corner portion at the leading side in the direction of loading the recording tape cartridge 10 into a drive device, is cut obliquely as seen in plan view. A space for accommodating the reel 14, on which the magnetic tape T is wound, is formed at the interior of the case 12.

The cut corner portions of the peripheral walls 16A, 18A form an opening 20 for the pulling-out of the magnetic tape T. A leader pin 22, which is pulled-out by a pull-out means of a drive device, is connected to the free end of the magnetic tape T which is pulled out from the opening 20. An annular groove 22A is formed in each of the end portions of the leader pin 22 which project out further than the transverse direction end portions of the magnetic tape T. Due to the annular grooves 22A being anchored by hooks or the like of the pull-out means, the hooks or the like do not contact and scratch the magnetic tape T at the time of pulling-out the magnetic tape T.

A pair of upper and lower pin holding portions 24, which position and hold the leader pin 22 at the interior of the case 12, are provided at the inner side of the opening 20 of the case 12. The pin holding portions 24 are formed in substantially semicylindrical shapes as seen in plan view, such that that magnetic tape T pull-out sides thereof are open. The end portions of the leader pin 22 which is in a state of standing upright can enter into and exit from the depressed portions 24A of the pin holding portions 24 from the open sides thereof.

In vicinities of the pin holding portions 24, a proximal portion 25A of the anchor spring 25 is inserted and fixed in spring holding portions 27 which are provided at the inner surface of the front wall 12A. The front wall 12A is the portions of the peripheral walls 16A, 18A where the outer surfaces face in the direction of arrow A. The distal ends (free ends) of the anchor spring 25, which have been divided so as to be forked in two, push the upper and lower ends of the leader pin 22 toward the inner sides of the pin holding portions 24, and thereby hold the leader pin 22 within the pin holding portions 24. When the leader pin 22 enters into and exits from the pin holding portions 24, the distal ends of the anchor spring 25 elastically deforms appropriately so as to permit movement of the leader pin 22.

A gear opening 26, which is for exposing an unillustrated reel gear of the reel 14 to the exterior, is formed in the central portion of the lower case 18. The reel 14 is driven to rotate within the case 12 by the reel gear meshing with a driving gear of a drive device. Further, the reel 14 is held so as to not joggle by movement restricting walls 28 which partially project out at the inner surfaces of the upper case 16 and the lower case 18, and which serve as inner walls which are on a circular locus which is coaxial with the gear opening 26.

An enclosure 28A, in which a hole for position regulation is formed, is continuous with the end portion of the movement restricting wall 28 in a vicinity of the opening 20. Further, an enclosure 28B, in which is formed a hole for position regulation which is a long hole, stands erect in the space sandwiched between the front left corner portion of the case 12 and the movement restricting wall 28. The enclosures 28A, 28B are disposed on a single straight line which extends along the direction of arrow B. End portions of the movement restricting walls 28, except for the end portion thereof at which the enclosure 28A is continuous, are continuous with the peripheral wall 16A or the peripheral wall 18A of the case 12, so as to partition the outer sides of the movement restricting walls 28 and the space at which the reel 14 is set.

A memory board M, which stores various types of information, is set at the rear right portion of the lower case 18 for each recording tape cartridge 10. A portion of a rear wall 18C forming the peripheral wall 18A is inclined at a predetermined angle and the memory board M is disposed so as to be inclined at a predetermined angle, such that sensing is possible at a drive device which reads from the bottom surface side and at a library device which reads from the rear surface side.

Further, a write-protect tab 60, which is set so that recording of information onto the recording tape cartridge 10 is possible or is not possible, is provided at the left rear portion of the lower case 18. An operation projection 62 for manually operating the write-protect tab 60 projects from an opening 15, which is provided at a rear wall 18B of the lower case 18. An oval opening 17 where a distinction projection 64 for showing whether the drive 90 is recordable or not is located is formed on the bottom surface of the lower case 18.

In addition, a pair of short upper and lower sloped wall portions 30 are provided in a right end portion of a front wall 12A of the accommodating case 12. The sloped wall portions 30 define a front peripheral portion of the opening 20. The sloped wall portions 30 are each formed bent along the opening face of the opening 20 to be thicker than the front wall 12A. The sloped wall portions 30 are dust-proof walls in order not leave a space for dusts when the opening 20 is closed and the end of a door 50 (described below) inwardly enters. A pair of upper and lower screw bosses 32 is integrally formed inside the front wall 12A in the vicinity on the left side of the sloped wall portion 30.

A pair of upper and lower sloped wall portions 34 are provided inside a front end portion of right wall 12B (portion of the peripheral walls 16A and 18A in the direction of the arrow B) of the accommodating case 12. Each of the sloped wall portions 34 is shaped substantially along an outer peripheral surface of the door 50 (described below) in plan view. Front end portions of the sloped wall portions 34 define a rear peripheral portion of the opening 20. A pair of upper and lower screw bosses 36 are provided in front end portions of the sloped wall portions 34.

At the right wall 12B of the accommodating case 12, a slit 40 with a certain length is provided to be used as a window for communication between the inside and the outside of the accommodating case 12. The slit 40 is used to expose an operation protrusion 52 of the door 50. The slit 40 is formed by cutting off a front lower portion of the peripheral wall 16A of the upper case 16 constituting the right wall 12B, and is thereby formed open also toward the opening 20. Thus, the outer surface of the screw boss 36 in the upper case 16 is exposed through the slit 40. The slit 40 is often formed to have a portion of the peripheral wall 16A in order to ensure the rigidity of the case 1. The upper wall which defines the slit 40 is often made integrally with the sloped wall portion 34.

The slit 40 described above may be formed such that an upper end thereof is defined only by a top plate of the accommodating case 12 (top plate of the upper case 16). The peripheral wall 16A may be partly remained to maintain the stiffness of the accommodating case 12, such as strength against an impact caused by dropping the case. In this case, the upper wall defining the slit 40 may be provided integral with the sloped wall portion 34.

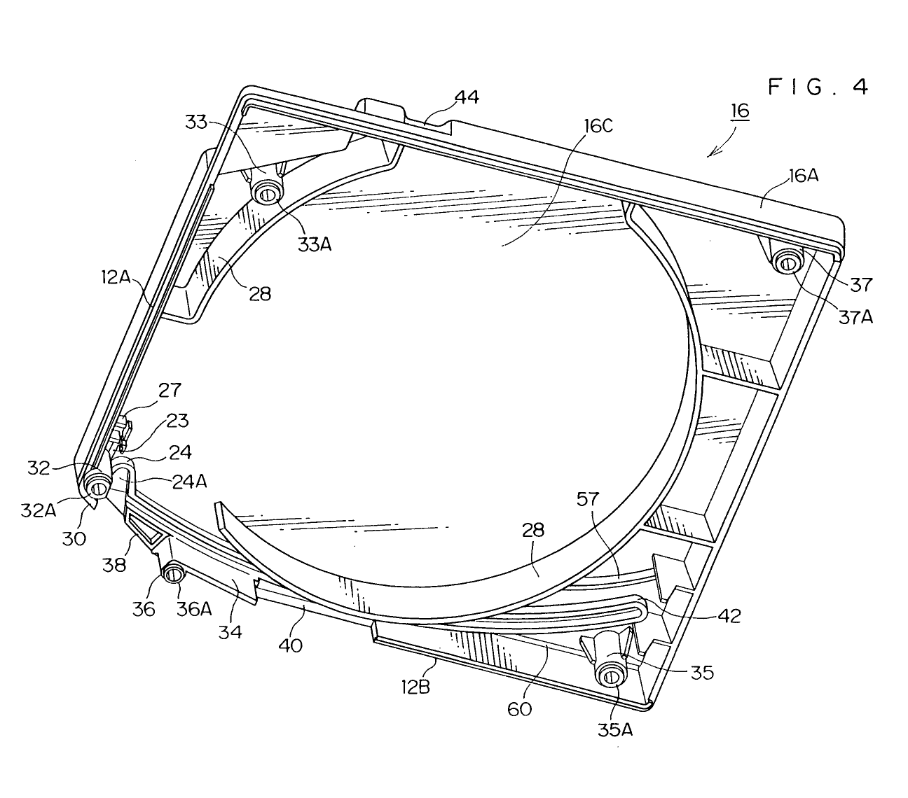

A concave portion 48 (cut-off portion of the bottom plate) is formed further rearwardly from the concave portion 44 in the lower case 18 (refer to FIG. 4). The concave portion 48 is formed such that a portion excluding an upper end of the peripheral wall 18A is concave similarly to the form of the letter “U” inwardly of the accommodating case 12 and, in addition, is concave upwardly from the lower surface of the accommodating case 12. The concave portion 48 is formed on the left wall of the accommodating case 12. This concave portion 48 is used, for example, as an engagement portion with which a pull-in means of the drive device is engaged. In addition, for example, a bottom surface (downward surface) of the concave portion 48 is used as a reference surface for performing positioning in the drive device 90.

Further, a concave portion 46 (cut-off portion of the bottom plate) is formed on a rear portion of the concave portion 48. These concave portions 46 are grasped portions into which are inserted and which engage with the claw portions 72 (see FIG. 8) of the robot hand 70 (grasping device) which is disposed in a vicinity of the library 100 shown in FIG. 10, or are anchoring/holding portions or grasped portions into which are inserted and which engage with the pair of claw portions 117 (see FIG. 9) which are provided at the side walls 112B of the accommodating chamber 112 of the library 110 shown in FIG. 11. The concave portion 46 is used as an engagement portion with which a claw 72 (FIG. 8) of a robot hand 70 provided in the vicinity of the library 100 engages. Alternatively, the concave portion 46 used as an engagement-retaining portion with which a pair of claws 117 (FIG. 9) located on side walls 112B of the chamber 112 of the library 110 shown in FIG. 11 engages.

With these concave portions 46 and 48, the torsion strength of the case 12 including the lower case 18 improves. A trapizoidal dented portion 44 is formed on the upper surface of the left wall 12C of the upper case 16. This dented portion 44 is used as an engagement portion where an unillustrated portion for canceling rotation moment due to the movement of the door 50 for opening.

In each of the upper and lower cases 16 and 18, a guide wall 42 with a certain height (for example, approximately in a range from 1.0 mm to 1.5 mm) is provided. The guide wall 42 extends from the vicinity of the opening 20 to the vicinity of a position at which the movement restricting walls 28 is proximate to the accommodating case 12 (the position hereinbelow will be referred to as the “first half”). The guide wall 42 extends to the vicinity of the rear wall either from the concave portion 44, which defines the rear end of the slit 40, or from the concave portion 44 (the position hereinbelow will referred to as the “second half”). The guide wall 42 described above supports a convex portion 51 of the door 50 (described below) in such a manner as to sandwich it from two sides of an inner surface and an outer surface thereof.

The guide walls 42 are formed substantially arc-shaped in plan view. The guide walls 42 in the upper and lower cases 16 and 18 are formed mutually different in length. Specifically, the second half of the guide wall 42 in the upper case 16 is formed longer than that in the lower case 18. This is because the memory board M is provided to be inclined at a certain angle at the right wall 12B of the lower case 18.

Further, the rear end portions of the guide wall portions 42 are closed in substantial arc-shapes as seen in plan view, and restrict the convex portions 51 which are furthest toward the rear at both the top and bottom of the door 50 such that the door 50 cannot move any further rearward. The front end portions of the guide wall portions 42 extend to positions which, when the leader pin 22 is entering and exiting, do not impede the entry or exit of the leader pin 22. Such positions are about half of the opening width and which are further rearward than pin holding portions 24 in this embodiment. The convex portions 51 which are furthest toward the front at both the top and bottom of the door 50 are restricted such that the door 50 is closed and cannot move any further forward.

In the vicinity of the inclined wall portions 30 as well, guide wall portions 41, whose rear end portions are open, stand erect so as to be positioned on imaginary lines extending from the guide wall portions 42. The rear end portions of the guide wall portions 41 do not extend further rearward than the front ends of the pin holding portions 24, so as to not impede entry and exit of the leader pin 22. The interval (groove width) of the guide wall portion 41 is slightly narrower than the interval (groove width) of the guide wall portion 42.

Namely, the interval (groove width) of the guide wall portion 42 is formed to be slightly wider in order to permit dispersion in molding of the door 50 (dispersion in the curvature of the door 50). The convex portions 51 of the door 50 slide within the guide wall portions 42 in a state in which the convex portions 51 joggle to a certain extent. Accordingly, the interval (groove width) of the guide wall portion 41 is made to be substantially the same size as the width of the convex portion 51 of the door 50 (the width including projections which will be described later) When the opening 20 is closed, due to the front most convex portions 51 entering in the guide wall portions 41, the door 50 can be held without joggling.

The first half of the guide wall 42 is formed somewhat lower than the second half of the guide wall 42. The first half of the guide wall 42 is formed to a height of around 1 mm, whereas the second half of the guide wall 42 is formed to a height of around 1.5 mm. The guide wall 42 is thus formed to secure spacing of the opening 20 to be sufficient to allow entrance of the pull-out means of the drive device that chucks the leader pin 22 to pull it out. For this reason, as described below, the door 50 in the first-half portion (at least a portion for blocking the opening 20) has a plate width (height) larger (higher) than the smaller height of the guide wall 42.

On an inner surface of each of the upper and lower cases 16 and 18, a rib 38 is formed integral with the outer guide wall 42 exposed to the outside through the opening 20 to have a substantially trapezoidal shape in plan view. The rib 38 is formed to a height equal to the height of the aforementioned guide wall 42. The rib 38 works to secure the strength of each of the upper and lower cases 16 and 18 in the portion of the opening 20. The inner guide wall 42 is integrally formed with the pin holder 24. The pin holder 24 may be formed to a height substantially equal to or higher than the height of the integrally formed guide wall 42.

As described above, the upper case 16 and the lower case 18 are fixed (coupled) with unillustrated screws inserted from the underside into the screw bosses 32 and 36 positioned in the vicinity of the opening 20. The corner portions at two ends of the opening 20 are insufficient in strength and tend to collide with the ground in an event the accommodating case 12 is dropped. In the structure described above, the corner portions are defined by individual free ends of the sloped wall portion 30 (front wall 12A) and the sloped wall portions 34 (right wall 12B) and are strongly coupled. Thus, even when dropped, the accommodating case 12 is neither deformed nor buckled due to the weight of the overall recording tape cartridge 10. A portion where the peripheral walls 16A and 16B are joined at both corners of the opening 20 may be welded for fixing. For taking parts apart and recycling, the portion may be screwed for fixing.

The opening 20 is opened and closed by the door 50 which serves as a closing member. The plate width (height) of at least the portion of the door 50 for closing the opening 20 is substantially the same as the opening height of the opening 20 as shown in FIG. 2. The plate length of this portion is formed to be sufficiently larger than the opening width of the opening 20. Further, the door 50 is formed in a substantial arc-shape in plan view which is curved in the direction of the plate thickness, so that the door 50 can move along a predetermined circumference.

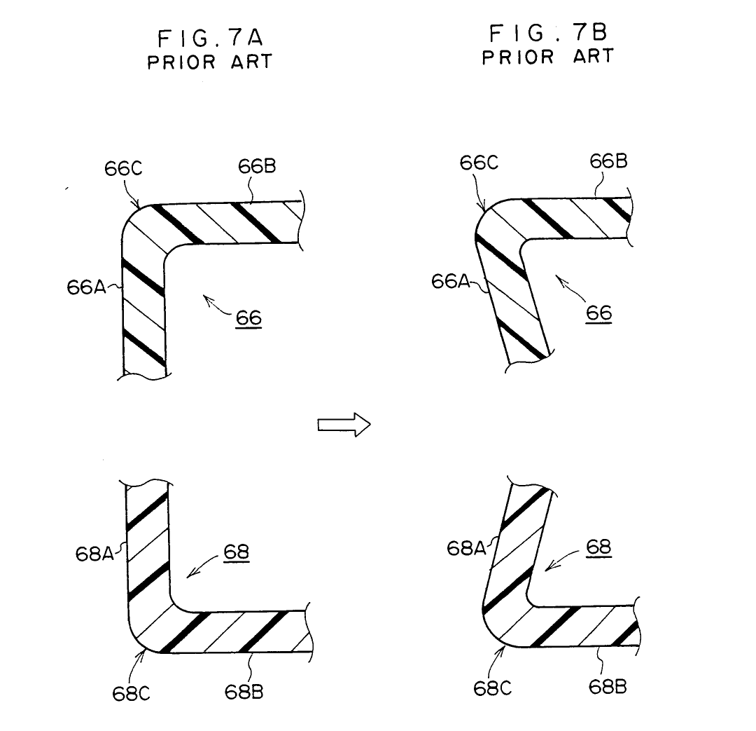

The door 50 closes the opening 20 in a state in which the distal end portion of the door 50 has entered into the concave portions 30A of the inclined wall portions 30 (FIG. 7A). When the door 50 slides (rotates) substantially rearwardly along the aforementioned predetermined circumference so as to open the opening 20 (FIG. 7B), and the outer peripheral surface in the vicinity of the distal end of the door 50 reaches a vicinity of the screw bosses 36, the opening 20 is completely opened (FIG. 7C). Further, the door 50 closes the opening 20 by sliding (rotating) in the direction opposite to the direction at the time of opening the opening 20.

As described above, the door 50 is arc-shaped corresponding to the circumference predetermined as a movement locus thereof. In the present embodiment, a center of the rotational movement (pivot center) is determined such that the position in the left-right direction is set to the vicinity of the left end of the accommodating case 12, and the position in the front-rear direction is set to the vicinity of the rear end of the slit 40. Thereby, the movement locus of the door 50 becomes proximate to the right wall 12B of the accommodating case 12 in the vicinity of the slit 40. The rotation center and radius of the door 50 may appropriately be determined according to, for example, the positions of front and rear end portions (such as the sloped wall portion 30 and the screw boss 36) of the opening 20 and the opening-face angle of the opening 20. The positions of the front and rear end portions are determined according to requirements of the drive device, and the opening-face angle is determined according to requirements of the library device.

The plate length of the door 50 or the curved longitudinal dimension thereof is determined such that, in the state in which the door 50 closes the opening 20, the rear end portion of the driving portion 50B is positioned in the right rear corner portion of the case 12. Note that the bottom rear portion of the driving portion 50B is cut obliquely in order to avoid the memory board M which is disposed obliquely at the rear wall 18C.

A plurality of convex portions 51, which enter into the upper and lower guide grooves 42, project at the upper and lower ends of the door 50. The convex portions 51 abut guide surfaces (mutually opposing inner surfaces) of the guide walls 42 and an inner surface of the upper case 16 and an inner surface of the lower case 18 between the guide walls 42 to thereby guide the door 50 along the opening/closing direction. The convex portions 51 are each formed substantially elliptical (in plan view) along the lengthwise direction of the door 50, and four pieces thereof protrude on each of the upper and lower surfaces of the door 50 to be vertically symmetric except for the rearmost the convex portions 51. For example, the convex portions 51 in front of a border of two different widths of the door 50 are about 0.5 mm, and the rest of the convex portions 51 behind the border are about 1.5 mm. The rearmost convex portions 51 are provided asymmetric for the reason that the rear-lower portion of the door 50 is diagonally cut off.

The above arrangement enables reduction in the sliding resistance (friction) among the individual upper and lower convex portions 51, the individual inner surfaces of the upper and lower cases 16 and 18, and the individual guide surfaces of the guide walls 42. Consequently, the door 50 can be caused to slide smoothly. Meanwhile, the convex portion 51 formed substantially elliptical in plan view is superior in impact resistance to a convex portion 51 formed substantially circular in plan view. Hence, even when a force is imposed on the door 50 from a direction other than the opening/closing direction, the convex portion 51 will not be broken thereby.

As an operation portion, the operation protrusion 52 is formed along the radial direction of the door 50 on the outer peripheral surface in a portion located slightly forward from a longitudinal central portion of the door 50 in the vicinity of the boundary portion where the plate width of the door 50 is different. The operation protrusion 52 is exposed to the outside of the accommodating case 12 through the slit 40. In the closed state of the opening 20, the operation protrusion 52 is positioned in a portion slightly spaced away from the rear end of the screw boss 36, and can be operated through a portion opened forward in the slit 40. In the opened state of the opening 20, the operation protrusion 52 is positioned in a portion slightly spaced away from the rear end of the slit 40. The rearmost convex portion 51 abuts the rear end portion of the guide wall 42.

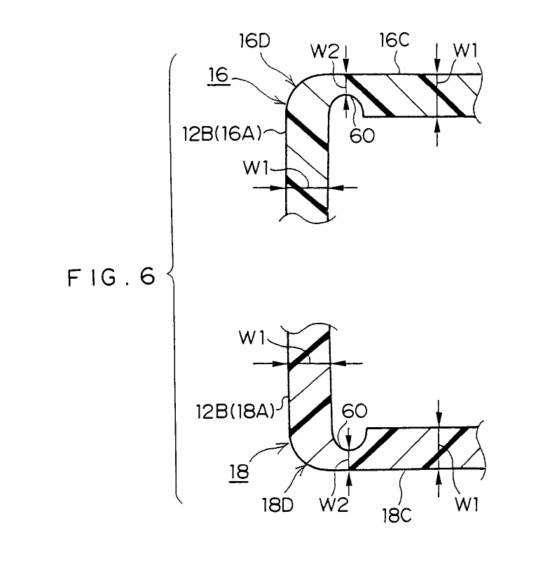

Stoppers 58, which abut the upper end portion side surface and the lower end portion side surface of the leader pin 22 when the opening 20 is closed, project at the inner surface of the front end portion of the door 50. The stoppers 58 can even more reliably prevent the leader pin 22 from falling out from the pin holding portions 24 due to impact if the recording tape cartridge 10 is dropped or the like. The coil spring 56, which serves as an urging member which urges the door 50 in the direction of closing the opening 20, is of a length such that it extends to the rear right corner portion of the case 12 in the state in which the door 50 closes the opening 20. Thus, as shown in FIG. 6, the space between the movement restricting wall 28 and the right wall 12B (the peripheral walls 16A, 18A) at this rear right corner portion can be utilized effectively.

Namely, a spring holding portion 54, which is substantially L shaped in rear view, projects upwardly and integrally at the inner peripheral surface of the door 50 in a vicinity of the rear end thereof. A solid cylindrical spring anchor portion 55 projects upwardly at the inner surface of the lower case 18 in a vicinity of the concave portion 48. Ring-shaped attachment portions 56A, 56B are formed at the ends of the coil spring 56. Accordingly, the coil spring 56 can be easily attached within the aforementioned space due to the one attachment portion 56B thereof being placed on the spring anchor portion 55 from above such that the spring anchor portion 55 is inserted therethrough, and the other attachment portion 56A thereof being placed on the spring holding portion 54 from above such that the spring holding portion 54 is inserted therethrough.

Accordingly, the application of a lubricant to the spring holding portion 54 and/or the rib 57, often to the spring holding portion 54 only may be performed. The resistance to sliding is thereby decreased at the time when the door 50 is opened. Moreover, in order to make the door 50 slide even more smoothly, a lubricant may be applied to the convex portions 51 and/or the guide wall portions 42, often to the convex portions 51 only. Namely, because the door 50 is formed in a substantial arc-shape as seen in plan view which curves along the direction of plate thickness thereof, the urging force of the coil spring 56, which is stretched rectilinearly between the spring holding portion 54 and the spring anchor portion 55, is not always applied parallel to the locus of movement of the door 50.

Thus, places where the convex portions 51 slide while pressing against the inner surfaces of the guide wall portions 42 inevitably exist (at the rear side in particular), and resistance to sliding, which albeit is slight, arises at the time when the door 50 opens and closes. Thus, the application of a lubricant may be performed to the outer peripheral surfaces of the convex portions 51 and/or the inner surfaces of the guide wall portions 42 so as to decrease the resistance to the sliding of the door 50 (i.e., so as to decrease the friction) as much as possible. The lubricant which is applied to the spring holding portion 54 or the rib 57, and to the convex portions 51 or the guide wall portions 42 is not particularly limited provided that it is a fluorine-based material or a silicon-based material. However, a lubricant which is dry in an environment of 23° C. to 25° C. is often selected.

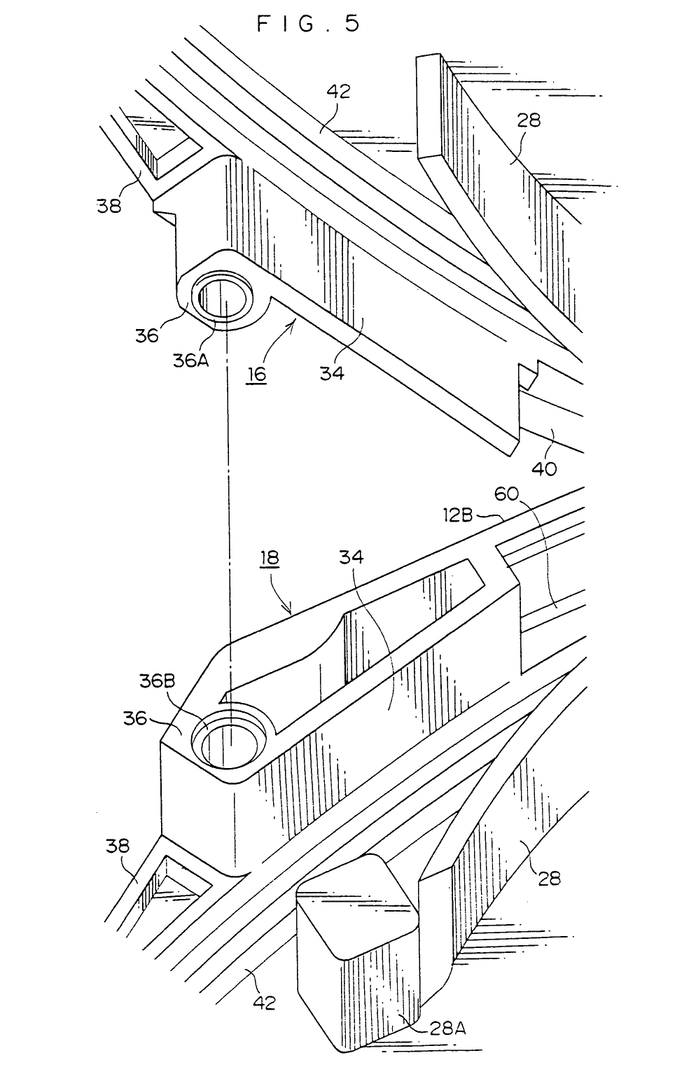

In the recording tape cartridge 10 having the above-described structure, as shown in FIGS. 2 through 6, groove portions 60 of a predetermined depth are formed along curved portions 16D, 18D (the right wall 12B), at the inner side of the right wall 12B where the door 50 slides, i.e., at the ceiling plate 16C side inner surface of the curved portion 16D which is the border portion between the ceiling plate 16C of the upper case 16 and the right wall 12B (the peripheral wall 16A), and at the floor plate 18C side inner surface of the curved portion 18D which is the border portion between the floor plate 18C of the lower case 18 and the right wall 12B (the peripheral wall 18A).

The depth of the groove portion 60 is formed to be 15% to 50% of a thickness W1 of the ceiling plate 16C, the floor plate 18C, and the right wall 12B (the peripheral walls 16A, 18A). A thickness W2 of the portion where the groove portion 60 is formed is formed to be 50% to 85% of the thickness W1. This is because, when the thickness W2 is more than 50% less than the thickness W1, the strength of the case 12 (the upper case 16 and the lower case 18) deteriorates. When the thickness W2 is more than 85% greater than the thickness W1, it is difficult for the synthetic resin at that portion to cool, the right wall 12B (the peripheral walls 16A, 18A) cools faster, and the right wall 12B (the peripheral walls 16A, 18A) leans in toward the inner side of the case 12.

Accordingly, by utilizing a thickness W2 within the aforementioned range, the strength of the case 12 (the upper case 16 and the lower case 18) does not deteriorate, and at the time of molding the upper case 16 and the lower case 18, the cooling time of the synthetic resin in the vicinities of the curved portions 16D, 18D can be made to be shorter than the cooling times of the ceiling plate 16C, the floor plate 18C, and the right wall 12B (the peripheral walls 16A, 18A), and the curved portions 16D, 18D can harden before the right wall 12B (the peripheral walls 16A, 18A). Therefore, it is possible to prevent the right wall 12B (the peripheral walls 16A, 18A) from leaning-in toward the inner side of the case 12.

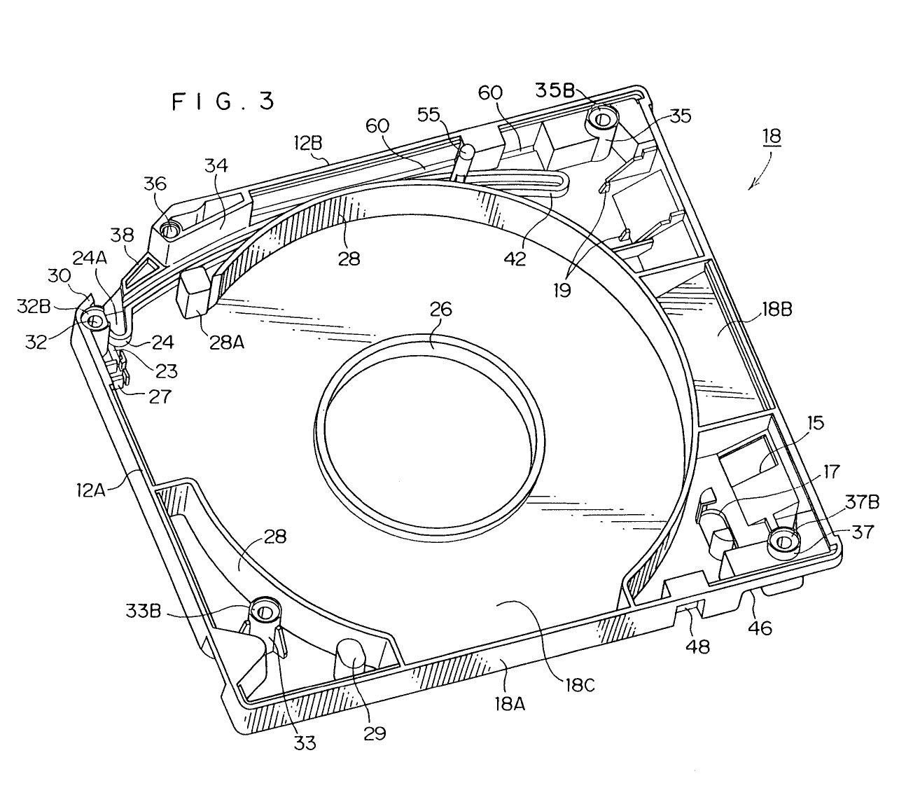

As described above, the upper case 16 and the lower case 18 are joined together by screws. As shown in FIGS. 3 through 5, tubular convex portions 32A, 33A, 35A, 36A, 37A are formed at the distal end portions (the bottom end portions) of screw bosses 32, 33, 35, 36, 37 of the upper case 16. Annular concave portions 32B, 33B, 35B, 36B, 37B are formed at the distal end portions (the top end portions) of the screw bosses 32, 33, 35, 36, 37 of the lower case 18. The respective distal ends of the screw bosses 32, 33, 35, 36, 37 abut one another and fit together with one another (a fitting-together of the convex and concave shapes).

Accordingly, when the upper case 16 and the lower case 18 are assembled together, the distal ends of the screw bosses 32, 33, 35, 36, 37 of the upper case 16 and the lower case 18 are assembled together well and accurately (even if there is slight positional offset, it is rectified) by this structure. Therefore, the insertion and screwing-in (joining) of the screws from the bottom surface (floor surface) of the lower case 18 can be carried out smoothly.

Accordingly, in the recording tape cartridge 10, strain or the like does not arise at the case 12, and the molding accuracy of the right wall 12B with respect to the ceiling plate 16C and the floor plate 18C is ensured. Therefore, the relative positional accuracy of the door 50 and the right wall 12B can be ensured, and the amount of projection of the operation projection 52 which projects from the slit 40 can be made to be a correct value. Accordingly, the amount of engagement of the operation projection 52 with the opening/closing member (not illustrated) of the drive device is optimal. When the recording tape cartridge 10 is loaded into a drive device, problems such as the door 50 not opening (the opening/closing member not engaging with the operation projection 52) and the like do not arise.

Note that the present invention is not limited to the illustrated structure, and a structure may be used in which the tubular convex portions 32A, 33A, 35A, 36A, 37A are formed at the screw bosses 32, 33, 35, 36, 37 of the lower case 18, and the annular concave portions 32B, 33B, 35B, 36B, 37B are formed at the screw bosses 32, 33, 35, 36, 37 of the upper case 16.

Next, operation of the present embodiment will be described. When the recording tape cartridge 10 having the above-described structure is not being used (i.e., is being stored, is being transported, or the like), the opening 20 is closed by the door 50. Specifically, due to the urging force of the coil spring 56, the door 50 is always urged in the direction of closing the opening 20, and closes the opening 20 in a state in which the distal end portion (front end portion) of the door 50 has entered in at the inner sides of the guide wall portions 41 and the inclined wall portions 30.

When the magnetic tape T is to be used, the recording tape cartridge 10 is loaded into a drive device along the direction of arrow A. Accompanying this loading, an opening/closing member (not illustrated), which forms an opening/closing means of the drive device, enters into the slit 40 which opens toward the front, and engages with the operation projection 52 of the door 50. In this state, when the recording tape cartridge 10 (the case 12) is pushed in further, due to the pushing-in force, the opening/closing member moves the operation projection 52 rearward against the urging force of the coil spring 56 (i.e., moves the operation projection 52 rearward relative to the case 12 which is loaded in the direction of arrow A).

Then, while the convex portions 51 are guided by the guide wall portions 42 and the spring holding portion 54 is guided by the rib 57, the door 50, from which the operation projection 52 projects, rotates clockwise as seen in plan view along the direction of curving thereof. Namely, due to the guide wall portions 42, the door 50 moves substantially rearward so as to circle around the outer sides of the pin holding portions 24 and the reel 14 without jutting out from the locus of movement along the curved configuration of the door 50, and opens the opening 20. Note that, at this time, because the lubricant has been applied to the convex portions 51 or the guide wall portions 42, and to the spring holding portion 54 or the rib 57, the door 50 rotates (moves) extremely smoothly. Then, when the case 12 (the recording tape cartridge 10) is loaded to a predetermined depth in the drive device, the opening 20 is completely opened.

When the recording tape cartridge 10 is positioned within the drive device in this state in which the opening 20 is opened, further rotation (substantially rearward movement) of the door 50 is restricted. The pull-out means of the drive device enters into the case 12 from the opening 20 which has been opened. The pull-out means pulls-out the leader pin 22 which is positioned and held at the pin holding portions 24. Then, the pull-out means accommodates the leader pin 22 at an unillustrated take-up reel, and the take-up reel and the reel 14 are driven to rotate synchronously. Thus, the magnetic tape T is successively pulled-out from the case 12 while being taken-up onto the take-up reel. Information is recorded or played back by a recording/playback head or the like disposed along the predetermined tape path.

When the recording tape cartridge 10 is to be ejected from the drive device, the magnetic tape T is rewound onto the reel 14, and the leader pin 22 is held at the pin holding portions 24. Then, the positioned state of the recording tape cartridge 10 is released, and the recording tape cartridge 10 is moved in the direction opposite to the direction of arrow A by the urging force of the coil spring 56 or by an unillustrated ejecting mechanism. In this way, while the convex portions 51 are guided by the guide wall portions 42, the door 50 is rotated in the direction of closing the opening 20 by the urging force of the coil spring 56, and the distal end portion (front end portion) of the door 50 enters into the guide wall portions 41 (enters in at the inner sides of the inclined wall portions 30). The opening 20 is thereby completely closed and returned to its initial state.

Here, the groove portions 60 are formed at the inner surface of the curved portion 16D which is the border portion between the ceiling plate 16C of the upper case 16 and the right wall 12B, and at the inner surface of the curved portion 18D which is the border portion between the floor plate 18C of the lower case 18 and the right wall 12B. The thickness W2 of these portions is formed to be thinner than the thickness W1 of the ceiling plate 16C, the floor plate 18C, and the right wall 12B (the peripheral walls 16A, 18A). Accordingly, falling-in of the right wall 12B toward the inner side of the case 12 due to the difference in the cooling times of the synthetic resin is prevented, and the molding accuracy of the right wall 12B with respect to the ceiling plate 16C and the floor plate 18C is ensured.

The distal ends of the screw bosses 32, 33, 35, 36, 37 provided at the upper case 16 and the lower case 18 are formed to be structures which fit-together in a convex and concave manner. Thus, the upper case 16 and the lower case 18 are assembled together accurately. Accordingly, strain or the like does not arise at the case 12, and the relative positions of the door 50 and the right wall 12B can be ensured accurately. Therefore, the operation projection 52, which projects out from the slit 40 of the right wall 12B, reliably engages with the opening/closing member of the drive device. Accordingly, problems such as the opening 20 not being able to be opened (the door 50 not being able to be moved) and the like do not arise.

As described above, in accordance with the present invention, it is possible to prevent a peripheral wall from falling-in toward the inner side of a case, and to improve the accuracy of assembling screw bosses together. Therefore, strain or the like does not arise at the case, and the relative positional accuracy of the peripheral wall and a shielding member, which opens and closes the opening, can be ensured. Accordingly, problems in the operations of opening and closing the shielding member do not arise.

What is claimed is:

1. A recording tape cartridge comprising:
a case which is substantially rectangular and is formed from an upper case, at which a peripheral wall stands erect at a ceiling plate, and a lower case, at which a peripheral wall stands erect at a floor plate, the case rotatably accommodating a single reel on which a recording tape is wound; and
at least one screw boss disposed at a predetermined position of the upper case and the lower case, for joining the upper case and the lower case together,
wherein the screw boss has a structure in which a convex portion and a concave portion are fit together, and
a thickness of a border portion between the peripheral wall and the ceiling plate and a border portion between the peripheral wall and the floor plate is formed to be thinner than a thickness of the peripheral wall.

2. The recording tape cartridge of claim 1, wherein the thickness of the border portions is a value which is 50% to 85% of the thickness of the peripheral wall.

3. The recording tape cartridge of claim 1, wherein a plurality of the screw bosses are provided.

4. The recording tape cartridge of claim 1, wherein the convex portion of the screw boss is provided at one of the upper case and the lower case, and the concave portion is provided at a case opposing the case at which the convex portion is provided.

5. The recording tape cartridge of claim 1, wherein the peripheral wall has a first peripheral wall and a second peripheral wall, and the border portions have a first border portion between the ceiling plate and the first peripheral wall and a second border portion between the floor plate and the second peripheral wall, and a groove is formed at an inner portion side of the case along the first border portion and the second border portion.

6. The recording tape cartridge of claim 1, wherein the border portions are curved portions.

7. The recording tape cartridge of claim 5, wherein a depth of the groove is a value which is from 15% to 50% of a thickness of at least the ceiling plate.

8. The recording tape cartridge of claim 7, wherein a thickness of portions of the first and second border portions where the groove is formed is a value which is from 50% to 85% of a thickness of the ceiling plate.

9. The recording tape cartridge of claim 7, wherein a depth of the groove is a value which is from 15% to 50% of a thickness of the floor plate.

10. The recording tape cartridge of claim 7, wherein a depth of the groove is a value which is from 15% to 50% of a thickness of the peripheral wall.

11. A method of ensuring relative positional accuracy of structural members of a recording tape cartridge comprising:
providing a case which is substantially rectangular and is formed from an upper case, at which a peripheral wall stands erect at a ceiling plate, and a lower case, at which a peripheral wall stands erect at a floor plate, the case rotatably accommodating a single reel on which a recording tape is wound; and at least one screw boss disposed at a predetermined position of the upper case and the lower case, for joining the upper case and the lower case together;
forming the screw boss as a structure in which a convex portion and a concave portion are fit together; and
forming a thickness of a border portion between the peripheral wall and the ceiling plate and a border portion between the peripheral wall and the floor plate to be thinner than a thickness of the peripheral wall.

12. The method of claim 11, further comprising a step of setting the thickness of the border portions to be a value which is 50% to 85% of the thickness of the peripheral wall.

13. The method of claim 11, further comprising a step of providing a plurality of the screw bosses.

14. The method of claim 11, wherein the step of forming the screw boss as a structure in which a convex portion and a concave portion are fit together includes a step of providing the convex portion of the screw boss at one of the upper case and the lower case, and providing the concave portion at a case opposing the case at which the convex portion is provided.

15. The method of claim 11, further comprising a step of forming a groove at an inner portion side of the case along a first border portion and a second border portion in which the peripheral wall has a first peripheral wall and a second peripheral wall, and the border portions have the first border portion between the ceiling plate and the first peripheral wall and the second border portion between the floor plate and the second peripheral wall.

16. The method of claim 11, further comprising a step of making the border portions be curved portions.

17. The method of claim 15, further comprising a step of setting a depth of the groove to be a value which is from 15% to 50% of a thickness of at least the ceiling plate.

18. The method of claim 17, further comprising a step of setting a thickness of portions of the first and second border portions where the groove is formed to be a value which is from 50% to 85% of a thickness of the ceiling plate.

19. The method of claim 17, further comprising a step of setting a depth of the groove to be a value which is from 15% to 50% of a thickness of the floor plate.

20. The method of claim 17, further comprising a step of setting a depth of the groove to be a value which is from 15% to 50% of a thickness of the peripheral wall.
